(19) United States
(12) Patent Application Publication
(10) Pub. No.: US 2012/0142297 A1
(43) Pub. Date: Jun. 7, 2012

(54) RECEIVER

(75) Inventors: Yasuo OBA, Shiga (JP); Eiji OKADA, Osaka (JP); Satoshi TSUKAMOTO, Osaka (JP)

(73) Assignee: PANASONIC CORPORATION, Osaka (JP)

(21) Appl. No.: 13/371,102

(22) Filed: Feb. 10, 2012

Related U.S. Application Data
(63) Continuation of application No. PCT/JP2010/006086, filed on Oct. 13, 2010.

(30) Foreign Application Priority Data
Mar. 19, 2010 (JP) 2010-064256

(51) Int. Cl. H04B 1/06

(52) U.S. Cl. 455/231

(57) ABSTRACT

A receiver includes an RF unit, a mixer which converts the output of the RF unit, a signal processing unit which filters the converted signal, a demodulator which demodulates the filtered signal, a level detector which compares a level of one of signals present between an input of the RF unit and an output of the signal processing unit with a threshold, a gain controller which generates a gain control signal based on the comparison result, a gate signal generator, and an interpolator. The receiver is configured such that a gain from the input of the RF unit to the output of the signal processing unit is changed in a stepwise manner. The gate signal generator generates a gate signal in synchronism with the gain change. The interpolator holds or interpolates the output of the demodulator for the time period represented by the gate signal.

### CROSS-REFERENCE TO RELATED APPLICATION

This is a continuation of PCT International Application PCT/JP2010/006086 filed on Oct. 13, 2010, which claims priority to Japanese Patent Application No. 2010-064256 filed on Mar. 19, 2010. The disclosures of these applications including the specifications, the drawings, and the claims are hereby incorporated by reference in its entirety.

### BACKGROUND

The present disclosure relates to receivers for receiving high-frequency signals, and more particularly to noise removal.

Mobile phones, television receivers, radio receivers, and receivers used for wireless communication generally require high dynamic ranges, and thus automatic gain control (AGC) is required. With the advancement of digital control technologies in recent years, AGC has been increasingly used in which the gain of an amplifier is changed in a stepwise manner. Providing control so that the gain of an amplifier takes discrete values requires digital circuits in addition to analog circuits, thereby causing the system size to increase as compared to when the gain is controlled only by analog circuits. However, due to many advantages in terms of improvement in distortion caused by nonlinearity of analog circuits, reduction in the number of external capacitors, easy integration into semiconductor integrated circuits, etc., an increasing number of receivers utilize amplifiers which change the gains in a stepwise manner.

Japanese Patent Publications Nos. 2004-048581 (Patent Document 1) and 2004-297137 (Patent Document 2) describe examples of receivers which change the gains in a stepwise manner.

### SUMMARY

However, an amplifier which changes the gain in a stepwise manner has a disadvantage in terms of noise generation upon a gain change in addition to the increase in circuit size, and therefore measures need to be taken depending on the field of application.

For example, the technology of Patent Document 1 utilizes, in combination, amplifiers which change the gains in a stepwise manner, and amplifiers which continuously change the gains. Even such a configuration still causes a discontinuity of gain. The technology of Patent Document 2 reduces the effects of noise upon a gain change by changing the threshold of a comparator in a binarization circuit based on the timing of the gain change. However, such a binarization circuit cannot be applied to a receiver which receives an analog modulated signal or a digital modulated signal having a complex structure such as an orthogonal frequency division multiplexing (OFDM) signal. In particular, when an analog broadcast signal carrying audio data is received, there is no time period for transmitting a control signal and/or a synchronization signal, and audio data is transmitted without interruption. Therefore, changing the gain in a stepwise manner causes noise to be added to the output audio data.

It is an object of the present disclosure to reduce noise generated when the gain of an amplifier is changed in a stepwise manner in a receiver.

A receiver according to the present disclosure is a receiver for receiving a radio frequency (RF) signal, and includes an RF unit configured to amplify the RF signal, and to output an amplified signal, a mixer configured to convert the output of the RF unit into a signal in a lower frequency band, and to output a converted signal, a signal processing unit configured to filter the converted signal, and to output a filtered signal, a demodulator configured to demodulate the filtered signal, and to output a demodulated signal, a first level detector configured to compare a level of one of signals present between an input of the RF unit and an output of the signal processing unit with a first threshold, and to output a result as a first comparison signal, a gain controller configured to generate a gain control signal based on the first comparison signal, a gate signal generator, and an interpolator. The receiver is configured such that a gain from the input of the RF unit to the output of the signal processing unit is changed in a stepwise manner based on the gain control signal. The gate signal generator generates a gate signal representing a predetermined time period in synchronism with the gain change. The interpolator holds or interpolates the output of the demodulator for the time period represented by the gate signal.

With such a configuration, the output of the demodulator is held or interpolated for the time period represented by the gate signal synchronous to a gain change, thereby allowing the noise generated on the demodulated signal upon a gain change to be reduced.

According to the present disclosure, noise generated when the gain of an amplifier is changed in a stepwise manner in a receiver can be reduced. Thus, among others, the quality of an audio signal output from a receiver which receives an analog broadcast signal can be improved.

### BRIEF DESCRIPTION OF THE DRAWINGS

FIG. 1 is a block diagram illustrating an example configuration of a receiver according to an embodiment of the present invention.

FIG. 2 is a block diagram illustrating an example configuration of a level detector of FIG. 1.

FIG. 3 is a diagram illustrating an example operation of the comparators of FIG. 2.

FIG. 4 is a circuit diagram illustrating an example configuration of an amplifier used in the receiver of FIG. 1.

FIG. 5 is a diagram illustrating an example relationship between the resistance value and the corresponding gain for each of the resistors included in the resistor unit of FIG. 4.

FIG. 6 is a graph showing example waveforms of signals in the receiver of FIG. 1.

FIG. 7 is a block diagram illustrating another example configuration of the receiver according to the embodiment of the present invention.

### DETAILED DESCRIPTION

An example embodiment of the present invention will be described below with reference to the drawings, in which reference numbers having the same last two digits indicate components corresponding to one another, and indicate the same or similar components. A solid line between function blocks in a drawing represents an electrical connection.

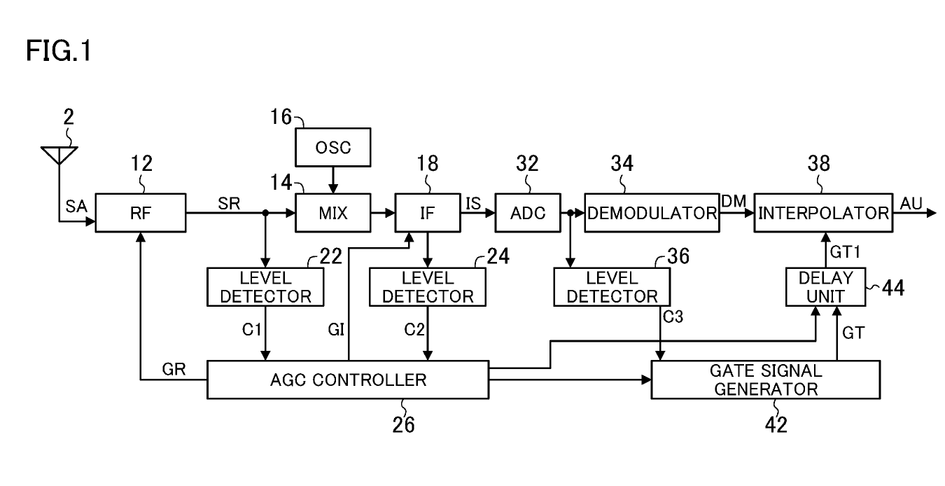

FIG. 1 is a block diagram illustrating an example configuration of a receiver according to an embodiment of the present invention. The receiver of FIG. 1 is a receiver for receiving a radio frequency (RF) signal received by an antenna 2 etc., and includes an RF unit 12, a mixer 14, a local oscillator 16, an intermediate frequency (IF) signal processing unit 18, level detectors 22, 24, and 36, an AGC controller 26, an analog-to-digital converter (ADC) 32, a demodulator 34, an interpolator 38, a gate signal generator 42, and a delay unit 44. The AGC controller 26, the demodulator 34, the interpolator 38, the gate signal generator 42, and the delay unit 44 are each formed by, for example, digital circuits.

The RF unit 12 of FIG. 1 includes an amplifier. The amplifier amplifies the RF signal SA received by the antenna 2, and outputs the amplified signal SR to the mixer 14. The amplifier performs amplification so that a gain dependent on a gain control signal GR is obtained. When changing the gain, the amplifier changes the gain based on the gain control signal GR in a stepwise manner. As used herein, the term to “amplify” also refers to a case of attenuation (a case where the gain is negative). The local oscillator 16 generates and outputs a signal having a frequency dependent on a signal to be received. The mixer 14 converts the signal SR into a signal in a lower frequency band (a signal in the IF band or a baseband signal) by multiplying the signal SR by the signal generated in the local oscillator 16, and outputs the converted signal to the IF signal processing unit 18.

The IF signal processing unit 18 includes an IF filter and an amplifier. In the IF signal processing unit 18, the IF filter performs a filtering operation to extract a signal in the IF band from the signal obtained by the mixer 14; and the amplifier amplifies the extracted signal, converts the amplified signal into a baseband signal, and outputs the obtained signal IS to the ADC 32. This amplifier performs amplification so that a gain dependent on a gain control signal GI is obtained. When changing the gain, the amplifier changes the gain based on the gain control signal GI in a stepwise manner.

The mixer 14 may convert the signal SR directly into a baseband signal. In this case, a signal processing unit performs a filtering operation to extract a signal in the baseband from the signal obtained by the mixer 14, amplifies the extracted signal, and outputs the obtained signal IS to the ADC 32 on behalf of the IF signal processing unit 18.

The ADC 32 converts the signal IS into a digital signal, and outputs the digital signal to the demodulator 34. The demodulator 34 includes an amplifier, demodulates the digital signal obtained by the conversion, and outputs the obtained demodulated signal DM (baseband signal) to the interpolator 38.

The level detector 22 compares the level of the output signal SR of the RF unit 12 with a predetermined threshold, and outputs the comparison result to the AGC controller 26 as a comparison signal C1. The level detector 24 compares the level of a signal of the IF signal processing unit 18 (i.e., the level of an internal signal of the IF signal processing unit 18 or the level of the output signal IS of the IF signal processing unit 18) with another predetermined threshold, and outputs the comparison result to the AGC controller 26 as a comparison signal C2. The level detector 22 or 24 may make a comparison using the level of any one of signals present between the input of the RF unit 12 and the output of the IF signal processing unit 18 (e.g., the output of the mixer 14). The level detector 36 compares the level of the output signal of the ADC 32 with a predetermined reference value, and outputs the comparison result to the gate signal generator 42 as a comparison signal C3.

The AGC controller 26 outputs a gain control signal GR or GI which decreases the gain of the RF unit 12 or the IF signal processing unit 18 if the comparison signal C1 or C2 indicates that the signal level is higher than the threshold, and outputs a gain control signal GR or GI which increases the gain of the RF unit 12 or the IF signal processing unit 18 if the comparison signal C1 or C2 indicates that the signal level is lower than the threshold. Thus, the level of the input signal SR to the mixer 14 or the level of the input signal IS to the ADC 32 is controlled so as to be appropriate. The AGC controller 26 is required to change only one of the gain control signal GR or GI.

The AGC controller 26 outputs the gain control signals GR and GI to the gate signal generator 42. The gate signal generator 42 outputs a pulse having a predetermined duration to the delay unit 44 as a gate signal GT based on the timing of a change in the gain control signal GR or GI, in other words, in synchronism with a change in the gain in the RF unit 12 or the IF signal processing unit 18. The delay unit 44 delays the gate signal GT, and outputs the delayed signal to the interpolator 38 as a gate signal GT1. The interpolator 38 holds or interpolates the demodulated signal DM for a time period represented by the gate signal GT1, and outputs the obtained signal AU.

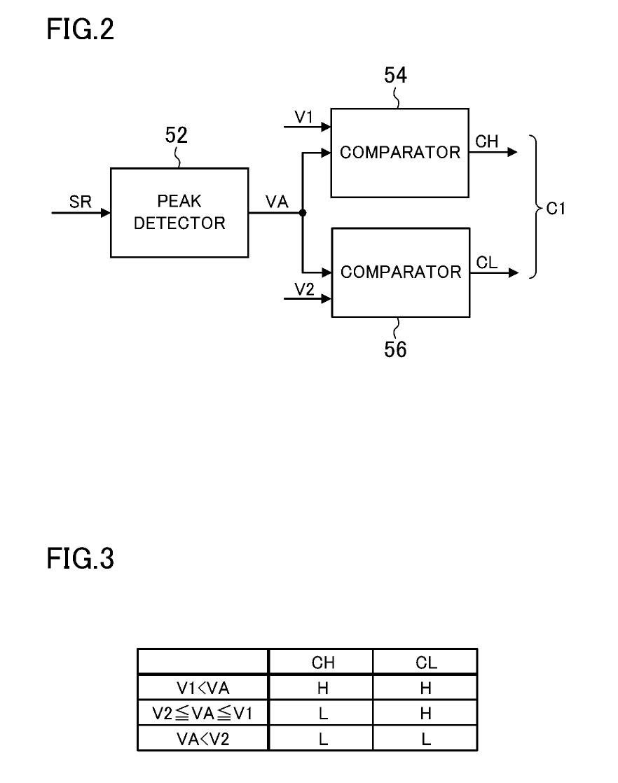

FIG. 2 is a block diagram illustrating an example configuration of the level detector 22 of FIG. 1. The level detector 22 includes a peak detector 52 and comparators 54 and 56. The peak detector 52 obtains a peak value of the input signal SR, and outputs a peak detection output VA representing the peak value to the comparators 54 and 56. The comparator 54 receives a reference voltage V1 as a threshold, and the comparator 56 receives a reference voltage V2 as a threshold. The reference voltage V1 is higher than the reference voltage V2.

FIG. 3 is a diagram illustrating an example operation of the comparators 54 and 56 of FIG. 2. The comparator 54 outputs, as an output signal CH, a high logic level (H) when the peak detection output VA is higher than the reference voltage V1, and a low logic level (L) when the peak detection output VA is lower than or equal to the reference voltage V1. The comparator 56 outputs, as an output signal CL, “H” when the peak detection output VA is higher than or equal to the reference voltage V2, and “L” when the peak detection output VA is lower than the reference voltage V2. FIGS. 1, 2, etc. show the output signals CH and CL together as the comparison signal C1. The level detector 24 of FIG. 1 is configured similarly to the level detector 22. FIG. 1 shows the output signals CH and CL of the level detector 24 together as the comparison signal C2.

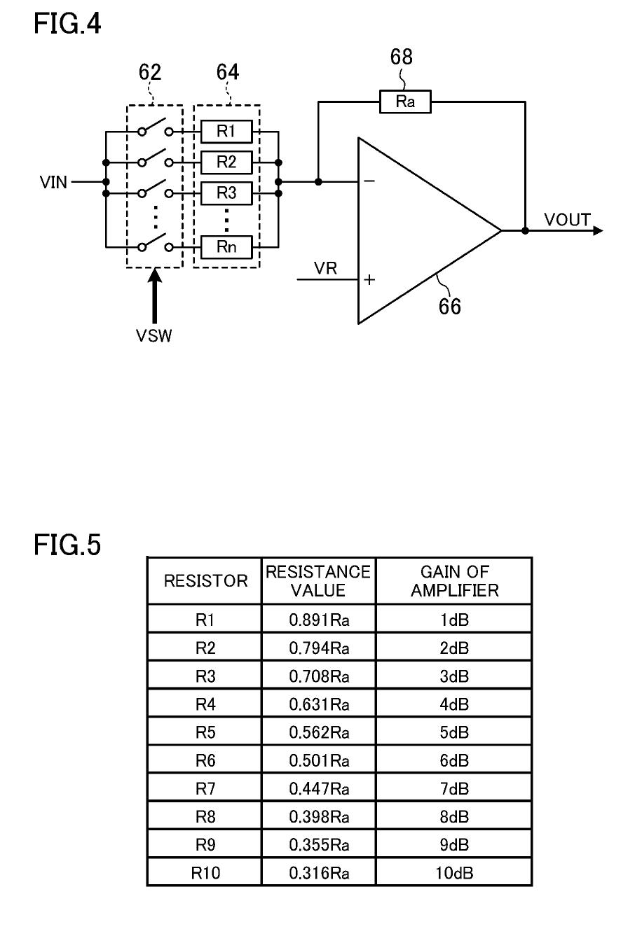

FIG. 4 is a circuit diagram illustrating an example configuration of an amplifier used in the receiver of FIG. 1. The amplifier of FIG. 4 includes a switch unit 62, a resistor unit 64, an operational amplifier 66, and a resistor 68 (Ra). The resistor unit 64 includes n (where n is an integer greater than or equal to 2) resistors R1, R2, R3, . . . , and Rn. The switch unit 62 includes n switches, which are respectively connected to the resistors R1-Rn in series. The non-inverting input node of the operational amplifier 66 receives the reference voltage VR.

The amplifier of FIG. 4 is an inverting amplifier. The n switches of the switch unit 62 are controlled by a control signal VSW. For example, when only the switch connected in series to the resistor Ri (where i is an integer satisfying 1≦i≦n) is turned on, the ratio of the output signal VOUT to the input signal VIN, that is, the gain GAi of this amplifier, is expressed as follows.

GAi=−(Ra/Ri).

Therefore, the gain of this amplifier can take discrete values.

FIG. 5 is a diagram illustrating an example relationship between the resistance value and the corresponding gain for each of the resistors R1-R10 included in the resistor unit 64 of FIG. 4. By appropriately setting the ratios of the values of the resistors R1-Rn to the value of the resistor Ra, a selection of a resistor (that is, turning on the corresponding switch) allows the gain to be changed in a stepwise manner with a fixed step size. For example, when n=10, the usage of the resistors R1-R10 having the resistance values shown in FIG. 5 allows discrete gains to be set with a step size of 1 dB.

The amplifiers of the RF unit 12, of the IF signal processing unit 18, and of the demodulator 34 are configured, for example, similarly to the amplifier of FIG. 4. These amplifiers may use capacitors in place of the resistors R1-Rn and Ra of FIG. 4, or may be amplifiers in which the gains can be set in a stepwise manner differently from the amplifier of FIG. 4. These amplifiers may be configured such that discrete gains can be set with a step size other than 1 dB. A part of these amplifiers may be not configured such that the gains can be changed. The RF unit 12 generates the control signal VSW based on the gain control signal GR, and thus controls the amplifier therein. The IF signal processing unit 18 generates the control signal VSW based on the gain control signal GI, and thus controls the amplifier therein.

The AGC controller 26 generates the gain control signal GR based on the signal C1 output from the level detector 22, and controls the gain of the amplifier in the RF unit 12 by means of the gain control signal GR. The AGC controller 26 generates the gain control signal GR so as to decrease the gain of the amplifier in the RF unit 12 by one step size when the output signals CH and CL constituting the signal C1 are both “H,” and to increase the gain of the amplifier by one step size when the output signals CH and CL are both “L.”

For example, the difference between the reference voltages V1 and V2 is set to the step size between the gains settable to the amplifier of FIG. 4. Thus, automatic gain control can be provided. Then, for example, as shown in FIG. 5, the step size between the gains settable to the amplifier is set to 1 dB, and the reference voltage V1 is set to a voltage which is 1 dB higher than the reference voltage V2.

When the peak level of the input signal SR of the level detector of FIG. 2 exceeds the reference voltage V1, the output signals CH and CL both go “H,” thereby causing the gain of the amplifier to be decreased by 1 dB. Meanwhile, when the peak level of the input signal SR falls below the reference voltage V2, the output signals CH and CL both go “L,” thereby causing the gain of the amplifier to be increased by 1 dB. Thus, automatic gain control is provided so that the level of the output signal of the amplifier remains constant.

If the level of the input signal SR changes significantly, the above operation is repeated. When the resistance values are set as shown in FIG. 5, and the level of the input signal SR changes by 5 dB, the gain change operation is repeated five times to keep the output level of the amplifier constant. A larger step size may be used for a gain change so that a larger change in the signal level can be handled. Alternatively, a smaller step size may be used for a gain change. In doing so, noise upon gain switching is reduced. However, to fully cover the gain changing range, the number of steps needs to be increased, thereby causing the circuit area to be increased. Accordingly, the step size is determined depending on both the circuit area and the use of the receiver.

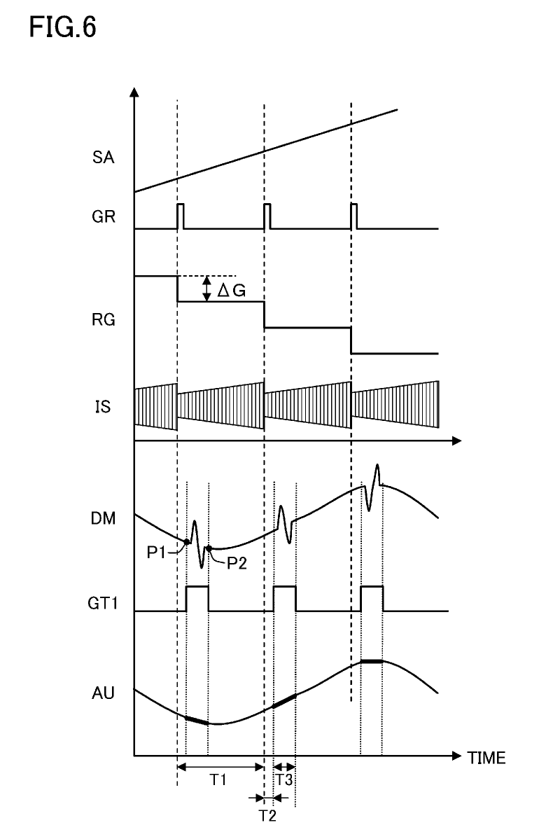

FIG. 6 is a graph showing example waveforms of signals in the receiver of FIG. 1. FIG. 6 illustrates signal waveforms when the level of the signal SA input from the antenna 2 to the RF unit 12 increases with time.

When the levels of the signal SA and of the signal SR output from the RF unit 12 increase, and the level of the signal SR exceeds the reference voltage V1 of the level detector 22, the level detector 22 outputs “H” to the AGC controller 26 as the output signals CH and CL constituting the signal C1. The AGC controller 26 drives the gain control signal GR “H” so as to decrease the gain of the RF unit 12. The RF unit 12 decreases the gain RG of the amplifier therein by an amount ΔG in a stepwise manner as shown in FIG. 6. A subsequent decrease of the level of the signal SR causes the signal C1 to change, and thus the AGC controller 26 drives the gain control signal GR “L.” The continuing increase in the level of the signal SA causes a similar operation to be repeated.

Instead of changing the gain of the amplifier of the RF unit 12, the gain of the amplifier of the IF signal processing unit 18 may be changed. In such a case, the operation is performed as follows. When the level of the signal SA increases, and the level of the signal IS or the signal in the IF signal processing unit 18 exceeds the reference voltage of the level detector 24, the level detector 24 outputs “H” to the AGC controller 26 as the output signals CH and CL constituting the signal C2. The AGC controller 26 drives the gain control signal GI “H” so as to decrease the gain of the IF signal processing unit 18. The IF signal processing unit 18 decreases the gain of the amplifier therein by an amount ΔG in a stepwise manner as shown in FIG. 6. A subsequent decrease in the level of the signal IS or the level of the signal in the IF signal processing unit 18 causes the signal C2 to change, and thus the AGC controller 26 drives the gain control signal GI “L.” The continuing increase in the level of the signal SA causes a similar operation to be repeated.

The AGC controller 26 may generate the gain control signal GR based on the signal C2, and may generate the gain control signal GI based on the signal C1. The AGC controller 26 is required to control only one of the amplifier of the RF unit 12 or the amplifier of the IF signal processing unit 18.

The signal IS input to the ADC 32 changes as shown in FIG. 6. Since the period of the signal IS is shorter than the change interval T1 of the gain, only the envelop is shown here. A change in the gain RG of the amplifier causes the level of the signal IS to rapidly change. Accordingly, demodulation of such signal IS by the demodulator 34 adds noise to the obtained demodulated signal DM immediately after a change in the gain RG as shown in FIG. 6. The characteristics of generated noise depend on the modulation scheme.

The gate signal generator 42 generates a pulse as the gate signal GT based on the timing of the gain control signal GR or GI. The duration T3 of the pulse is, for example, several tens to several hundreds of microseconds (μs) when an audio signal is received. The gate signal generator 42 is notified of the modulation scheme of the received signal SA by a microcontroller etc. which controls the receiver of FIG. 1. The optimum value of the duration T3 of the pulse depends on the modulation scheme and on the frequency of the received signal SA.

If the received signal SA is modulated using a modulation scheme which keeps the amplitude constant such as frequency modulation (FM), noise generated upon a gain change has relatively small effects on the phase and the frequency of the signal, and thus only low noise is present in the demodulated signal DM. Meanwhile, if the received signal SA is modulated using a modulation scheme such as amplitude modulation (AM), noise generated upon a gain change has a direct effect on the demodulated signal DM. Accordingly, the gate signal generator 42 may set the length of the time period represented by the gate signal GT to a length dependent on the modulation scheme of the received RF signal SA. More specifically, when the received signal SA is modulated using a modulation scheme which transmits information using the amplitude (i.e., AM etc.), the gate signal generator 42 sets a higher value for the duration T3 of the pulse of the gate signal GT as compared to when the received signal SA is modulated using a frequency modulation scheme or a phase modulation scheme. For example, if the received signal SA is an FM signal, T3 is set to 20-30 μs, while, if the received signal SA is an AM signal, T3 is set to 100-200 μs.

The path along which the demodulated signal DM propagates to the interpolator 38 differs from the path along which the gate signal GT propagates to the interpolator 38. In general, a low-pass filter is inserted on the path on which the demodulated signal DM is demodulated, and thus the gate signal GT would reach the interpolator 38 earlier than the demodulated signal DM if no delays are provided. Thus, the delay unit 44 delays the gate signal GT by a delay T2 to synchronize the demodulated signal DM with the gate signal GT, and then outputs the delayed signal to the interpolator 38 as the gate signal GT1. As described above, by providing the delay T2 to the gate signal GT, the delay unit 44 allows the time period of noise upon a gain change to be included in the duration of a pulse of the gate signal GT1.

The interpolator 38 holds or interpolates the demodulated signal DM for the duration of a pulse of the gate signal GT1, and outputs the obtained signal AU. FIG. 6 shows, by way of example, the signal AU obtained by an interpolation. In this case, the interpolator 38 performs a linear interpolation using the values of the demodulated signal DM at the start and the end of the time period represented by the gate signal GT1. More specifically, for example, the interpolator 38 connects points P1 and P2 of the demodulated signal DM by a straight line segment (the bold line of the signal AU of FIG. 6). The values of the points P1 and P2 are values of the demodulated signal DM at the times of the leading edge and the trailing edge of a pulse of the gate signal GT1. Storing the demodulated signal DM for the time period including the points P1 and P2 by the interpolator 38 allows such an operation to be easily performed. The interpolator 38 performs a similar operation also for the duration of other pulses of the gate signal GT1.

The interpolator 38 may calculate an (m−1)th order curve (where m is an integer greater than or equal to 3) using values of the demodulated signal DM at m time points (which may include the values at the points P1 and P2) in a time period other than the time period represented by the gate signal GT1, and then perform an interpolation using this curve. For example, the interpolator 38 calculates a quadric curve passing through the points P1 and P2 and a point at one time point not included in the duration of a pulse of the gate signal GT1 using the values of the demodulated signal DM at these points, and interpolates the demodulated signal DM for the duration of the pulse of the gate signal GT1 using the quadratic curve.

In addition, the interpolator 38 may hold the value of the modulated signal DM at the point P1 for the duration of a pulse of the gate signal GT1, instead of performing an interpolation as described above.

Thus, according to the receiver of FIG. 1, a gate signal is generated and the demodulated signal DM is, for example, interpolated based on the gate signal, and therefore noise added to the demodulated signal DM upon a gain change can be reduced.

A wide variation in the magnitude of the received signal will cause the gain to vary widely, and accordingly the step size of a gain change will need to be increased. In such a case, the duration of noise added to the demodulated signal DM becomes long, and the amount of the noise becomes large. In particular, in a receiver installed in a vehicle such as an automobile, a wide variation in the magnitude of the received signal causes the receiver to be greatly affected by such noise. Thus, the gate signal generator 42 may set the length of the time period represented by the gate signal GT to a length dependent on the step size of a gain change. For example, the gate signal generator 42 sets a higher value to the duration T3 of a pulse of the gate signal GT when the step size of a gain change is larger than a predetermined value, while the gate signal generator 42 sets a lower value to the duration T3 of a pulse of the gate signal GT when the step size of a gain change is smaller than or equal to the predetermined value. Thus, noise removal can be performed appropriately for each situation.

When the gain change is performed in the amplifier of the RF unit 12, the amount of delay from the amplifier to the output of the demodulator 34 is larger than that of when the gain change is performed in the amplifier of the IF signal processing unit 18. Thus, the AGC controller 26 notifies the delay unit 44 of which one of the RF unit 12 or the IF signal processing unit 18 has changed the gain, and the delay unit 44 delays the gate signal GT by a delay T2 dependent on which has changed the gain. More specifically, the delay unit 44 sets the delay T2 provided for the gate signal GT to a higher value when the RF unit 12 has changed the gain than when the IF signal processing unit 18 has changed the gain.

In particular, when a signal modulated using analog modulation is received, and the input level of the signal to the antenna is low, noise generated upon a gain change is smaller than other noise generated in the receiver, and thus there may be no need for the interpolator 38 to perform an interpolation etc. Accordingly, when the input level of the signal to the antenna is low, in order to prevent the signal-to-noise ratio (SNR) from being decreased due to noise generated by an interpolation etc., the interpolation by the interpolator 38 etc. may not be performed. More specifically, the gate signal generator 42 ceases generating the gate signal GT if the signal C3 indicates that the level of the signal compared in the level detector 36 is lower than a predetermined reference value.

In in-vehicle devices, noise cancellers configured to remove noise generated in automotive electronic components have been conventionally used. However, noise generated upon a gain change is smaller than noise generated in electronic components, and moreover, the duration of a generated pulse is shorter. Accordingly, it is difficult to detect the noise generated in electronic components and the noise generated upon a gain change both to a sufficient degree by a noise canceller.

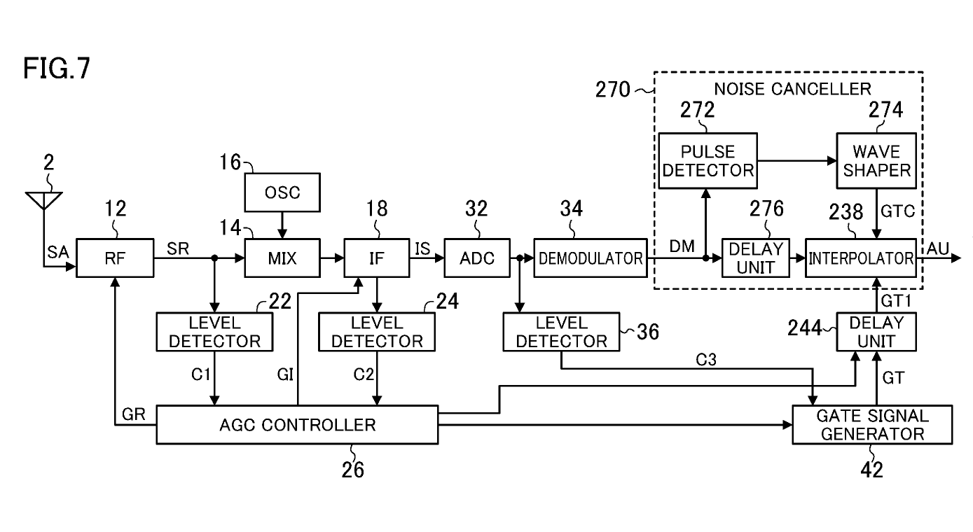

FIG. 7 is a block diagram illustrating another example configuration of the receiver according to the embodiment of the present invention. The receiver of FIG. 7 differs from the receiver of FIG. 1 in that the receiver of FIG. 7 further includes a pulse detector 272, a wave shaper 274, and a delay unit 276, and includes an interpolator 238 and a delay unit 244 in place of the interpolator 38 and the delay unit 44. The other part of the configuration is similar to that of the receiver of FIG. 1. The interpolator 238, the pulse detector 272, the wave shaper 274, and the delay unit 276 together form a noise canceller 270.

The pulse detector 272 detects noise in the form of pulse (impulse noise) included in the demodulated signal DM output from the demodulator 34. More specifically, the pulse detector 272 allows the demodulated signal DM to pass through a high-pass filter, and generates a pulse representing the time period during which the absolute value of the signal passed through the filter is greater than or equal to a threshold, and outputs the pulse to the wave shaper 274. The wave shaper 274 generates a noise cancellation signal GTC representing the duration of a detected impulse noise based on the detection result by the pulse detector 272. That is, the wave shaper 274 converts the sequential pulses generated by the pulse detector 272 into a single pulse having a duration which includes the duration of these pulses, and outputs the single pulse to the interpolator 238 as the noise cancellation signal GTC.

The delay unit 276 delays the demodulated signal DM so that the timing of the noise included in the demodulated signal DM is included in the duration of the pulse of the noise cancellation signal GTC, and outputs the delayed signal to the interpolator 238. The delay unit 244 delays the gate signal GT, and outputs the delayed signal to the interpolator 238 as the gate signal GT1. The delay provided by the delay unit 244 is greater than the delay provided by the delay unit 44 of FIG. 1 by the amount of the delay provided by the delay unit 276. The interpolator 238 operates similarly to the interpolator 38 of FIG. 1, and in addition, holds or interpolates the demodulated signal DM for the duration of the pulse of the noise cancellation signal GTC, and outputs the obtained signal AU. The method of interpolation performed by the interpolator 238 is similar to that of the interpolator 38.

As described above, the noise canceller 270 can remove impulse noise such as noise generated in automotive electronic components and multipath noise. According to the receiver of FIG. 7, the interpolator 238 performs both removal of noise generated upon a gain change similar to that of the receiver of FIG. 1 and removal of impulse noise as the noise canceller 270; and thus the circuit size of the receiver can be reduced as compared to when two independent interpolators are utilized for removing such two types of noise. Thus, the cost of a receiver can be reduced.

Since the receiver of FIG. 7 includes the pulse detector 272 for detecting impulse noise, impulse noise can be easily detected. In addition, the receiver of FIG. 7 includes two delay units 244 and 276, and therefore a delay suitable for removing noise generated upon a gain change and a delay suitable for removing impulse noise can be individually set. Accordingly, both type of noise can be effectively removed.

Although, in the above embodiment, the IF signal processing unit 18 has been described as being formed by analog circuits, the configuration may be such that the output signal of the mixer 14 is converted into a digital signal, and the IF signal processing unit 18 receiving this digital signal is formed by digital circuits.

Each function block described herein can typically be implemented in hardware. For example, each function block can be formed on a semiconductor substrate as a part of an integrated circuit (IC). Here, the term “IC” includes large-scale integrated circuit (LSI), application-specific integrated circuit (ASIC), gate array, field programmable gate array (FPGA), etc. As another alternative, a part or all of each function block can be implemented in software. For example, such a function block can be implemented by a program executed by a processor. In other words, each function block described herein may be implemented in hardware, software, or any combination of hardware and software.

All blocks of the receiver of FIG. 1 or 7 may be formed on a same semiconductor chip, or the blocks of the receiver of FIG. 1 or 7 may be formed on respectively corresponding semiconductor chips, and the semiconductor chips may together form the receiver.

As described above, according to the present invention, noise generated when the gain of an amplifier is changed in a stepwise manner can be reduced, and thus the present invention is useful for receivers etc., and is useful for, for example, in-vehicle receivers which receive analog broadcast signals etc.

What is claimed is:

1. A receiver for receiving a radio frequency (RF) signal, comprising:
an RF unit configured to amplify the RF signal, and to output an amplified signal;
a mixer configured to convert the output of the RF unit into a signal in a lower frequency band, and to output a converted signal;
a signal processing unit configured to filter the converted signal, and to output a filtered signal;
a demodulator configured to demodulate the filtered signal, and to output a demodulated signal;
a first level detector configured to compare a level of one of signals present between an input of the RF unit and an output of the signal processing unit with a first threshold, and to output a result as a first comparison signal;
a gain controller configured to generate a gain control signal based on the first comparison signal;
a gate signal generator; and
an interpolator,
wherein
the receiver is configured such that a gain from the input of the RF unit to the output of the signal processing unit is changed in a stepwise manner based on the gain control signal,
the gate signal generator generates a gate signal representing a predetermined time period in synchronism with the gain change, and
the interpolator holds or interpolates the output of the demodulator for the time period represented by the gate signal.

2. The receiver of claim 1, wherein
the RF unit changes a gain thereof in a stepwise manner based on the gain control signal.

3. The receiver of claim 1, wherein
the signal processing unit changes a gain thereof in a stepwise manner based on the gain control signal.

4. The receiver of claim 1, further comprising:
a second level detector configured to compare a level of a signal of the signal processing unit with a second threshold, and to output a result as a second comparison signal; and
a delay unit configured to delay the gate signal generated in the gate signal generator, and to output a delayed gate signal, wherein
the interpolator holds or interpolates the output of the demodulator for the time period represented by the delayed gate signal,
the gain controller generates the gain control signal based on the first or the second comparison signal,
when the gain controller generates the gain control signal based on the first comparison signal, the RF unit changes a gain thereof based on the gain control signal,
when the gain controller generates the gain control signal based on the second comparison signal, the signal processing unit changes a gain thereof based on the gain control signal, and
the delay unit provides a delay corresponding to either the RF unit or the signal processing unit, which has changed the gain thereof, to the gate signal.

5. The receiver of claim 1, wherein
the gate signal generator sets a length of the time period represented by the gate signal to a length corresponding to a step size of the gain change.

6. The receiver of claim 1, wherein
the gate signal generator sets a length of the time period represented by the gate signal to a length corresponding to a modulation scheme of the RF signal.

7. The receiver of claim 1, further comprising:
a second level detector configured to compare a level of a signal present between the input of the RF unit and the output of the signal processing unit with a reference value, and to output a result as a second comparison signal,
wherein
the gate signal generator ceases generating the gate signal if the second comparison signal indicates that the level of the signal compared is lower than the reference value.

8. The receiver of claim 1, wherein
the interpolator performs a linear interpolation using values of the output of the demodulator at a start and an end of the time period represented by the gate signal.

9. The receiver of claim 1, wherein
the interpolator performs an interpolation with an (m−1)th order curve (where m is an integer greater than or equal to 3) using values of the output of the demodulator at m time points in a time period other than the time period represented by the gate signal.

10. The receiver of claim 1, further comprising:
a pulse detector configured to detect impulse noise from the output of the demodulator; and
a wave shaper configured to generate a noise cancellation signal representing a duration of a detected impulse noise based on a detection result by the pulse detector,
wherein
the interpolator holds or interpolates the output of the demodulator also for the duration represented by the noise cancellation signal.
